(19) United States
(12) Patent Application Publication
(10) Pub. No.: US 2003/0216509 A1
(43) Pub. Date: Nov. 20, 2003

(54) Substantially random interpolymer grafted witn one or more olefinically unsaturated organic monomers

(76) Inventors: Gabriele Goethel, Merseburg (DE); Michael E Rowland, Lake Jackson, TX (US); Martin J Guest, Rheinmunster (DE); Steve R Betso, Bedminster, NJ (US); Karin Katzer, Horgen (CH); Thomas T Allgeuer, Wollerau (CH); Ronald Wevers, Terneuzen (NL); Hari P Reddy, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/276,087

(22) PCT Filed: May 24, 2001
(86) PCT No.: PCT/US01/16934

(30) Foreign Application Priority Data
May 26, 2000 (WO) PCT/EP00/04841

(51) Int. Cl. C08F 265/02; C08F 267/02

(52) U.S. Cl. 525/70; 525/242; 525/301

(57) ABSTRACT

A graft polymer according to the invention contains a backbone of one or more substantially random interpolymers, comprising: (1) polymer units derived from: (a) at least one vinyl or vinylidene aromatic monomer, or (b) at least one hindered aliphatic or cycloaliphatic vinyl or vinylidene monomer, or (c) a combination of at least one aromatic vinyl or vinylidene monomer and at least one hindered aliphatic or cycloaliphatic vinyl or vinylidene monomer, and (2) polymer units derived from at least one of ethylene and/or a C₃₋₂₀ α-olefin; and (3) optionally polymer units derived from one or more of ethylenically unsaturated polymerizable monomers other than those derived from (1) and (2); said backbone being grafted with one or more olefinically unsaturated organic monomer(s). In a preferred embodiment such graft polymers were prepared using a reactive extrusion process.

### FIELD OF THE INVENTION

This invention relates to graft substantially random interpolymers which have been grafted with one or more olefinically unsaturated organic monomers . The substantially random interpolymers comprise polymer units derived from at least one aliphatic olefin monomer having from 2 to 20 carbon atoms and polymer units derived from at least one vinyl or vinylidene aromatic monomer and/or from at least one hindered aliphatic or cycloaliphatic vinyl or vinylidene monomer. The invention further relates to blends of such graft interpolymers with one or more olefin or non-olefin polymers, grafted or ungrafted. This invention includes multilayer structures comprising at least one layer of a graft substantially random interpolymer and a composite comprising such interpolymer. The invention also provides applications for the graft substantially random, for example in shaped and fabricated articles, including fibers.

### BACKGROUND OF THE INVENTION

The generic class of materials encompassing interpolymers prepared by polymerizing ethylene and/or an alpha-olefin and at least one aromatic or (cyclo)aliphatic vinyl or vinylidene monomer, including such interpolymers which are substantially random interpolymers, are known in the art. For example, substantially random ethylene/styrene interpolymers have been described in EP-A416815, U.S. Pat. No. 5,703,187 and U.S. Pat. No. 5,872,201.

Some generic disclosure and limited references relating to grafted ethylene/styrene interpolymers can be found in the art. U.S. Pat. No. 6,015,625 relates to an adhesive resin composition containing at least a partially or wholly graft-modified alpha-olefin/aromatic vinyl compound random copolymer having a graft quantity of an unsaturated carboxylic acid or its derivatives ranging from 0.01 to 30 weight percent.

Grafted ethylene/α-olefin copolymers are, for example, described in EP-A-428 510, EP-A-439 079, EP-A-605 952, U.S. Pat. No. 4,762,890 and U.S. Pat. No. 5,705,565. Polar modified isotactic polypropylenes are also known. Such polar modified polypropylene may be useful as coupling agents in thermoplast-fiberglass composites and as self-adherent coating material for metal surfaces. In addition, there is a multitude of other potential uses for such graft polymers which are known to those skilled in the art.

Blends of, for example, maleic anhydride grafted olefin homo- and copolymers and polyolefins have been suggested for a broad range of applications, including, for example, food packaging films, especially multilayer films, flooring and carpet systems, or pipe coatings.

The materials known and used in the prior art, however, during their process of preparation and especially upon reactive extrusion show remarkable changes in molecular weight or molecular weight distribution. Such changes are undesired side effects resulting in increased molecular weight and gel formation (which occurs especially with polyethylene and ethylene copolymers) or in decreased molecular weight, corresponding to an increase in melt flow rate (which occurs especially with polypropylene and polypropylene copolymers containing predominantly propylene).

Although of utility in their own right, Industry is constantly seeking to further expand the applicability of the substantially random interpolymers. Furthermore, Industry seeks to provide novel interpolymers with improved and advantageous properties.

Various olefin fibers, that is fibers in which the fiber-forming material is a polymer based on ethylene, propylene or other olefin units are known from the prior art. EP-A-442 950 discloses fibers containing maleic anhydride (MAH) grafted linear polyethylene, preferably MAH-grafted high density polyethylene HDPE_{g} or MAH-grafted linear low density polyethylene (LLDPE_{g}). Owing to their adhesion to performance fibers and wettability thereof, such fibers are reported to be particularly useful in binder fiber applications. As a result of the graft modification, the melt index of the graft polymers is reported to decrease significantly relative to the melt index of the non-grafted starting materials. For example, the melt index of HDPE is found to decrease by a factor in the range of about 20 to about 70, depending on the graft level. The significant decrease in melt index correlates with a substantial increase in molecular weight. Such increase in molecular weight, e.g. resulting from cross-linking of the polymer, and the concomitant broadening of the molecular weight distribution are undesired side effects of the graft modification of the polymer, which adversely affect its processability during the fiber forming process. It is generally known in the art that conventional grafted polyethylenes, as used e.g. in polyethylene/polyester terephtalate (PET) bicomponent fiber applications, limit the productivity of the fiber spinning process, for example by generating fiber breaks, die pressure build up in the spinnerette and more frequent filter changes. Thus, there is the need for novel polymers with improved processability which avoid or at least reduce the shortcomings of the presently used materials and allow for higher productivity of a fiber forming process. It is the object of the present invention to meet the abovementioned and other needs. In particular, it is an object of the present invention to provide grafted interpolymers with excellent compatibility, processability and other beneficial properties, which can be prepared without a significant change in molecular weight or molecular weight distribution and/or without a substantial increase or decrease in melt flow rate, as compared to the corresponding non-grafted starting interpolymers. This invention provides a process for the preparation of grafted substantially random interpolymers having new and advantageous properties. It is another object of the present invention to provide applications of such graft interpolymers including, e.g., polymer compositions and formulations such as blends, and multilayer sheet and film materials as well as fibers which benefit from including such interpolymers. This invention provides for the utilization of the grafted substantially random interpolymers in a broad range of applications which benefit from the new and improved performance attributes, e.g. from the improved compatibility or bonding between system components. It is also an object of the present invention to provide a continuous process for interpolymer modification using grafting technology, wherein the interpolymer molecular weight changes little, if at all, as a result of the graft modification. The continuous process provided by the present invention involves the use of high shear and elevated temperatures, such as is encountered using extrusion technology.

### BRIEF SUMMARY OF TEE INVENTION

The present invention pertains to novel graft polymers with a backbone of one or more substantially random interpolymers as defined hereinbelow, the polymer backbone being grafted with at least one olefinically unsaturated organic monomer. In particular, the present invention pertains to a graft interpolymer comprising:

(1) polymer units derived from;

(a) at least one vinyl or vinylidene aromatic monomer, or

(b) at least one hindered aliphatic or cycloaliphatic vinyl or vinylidene monomer, or

(c) a combination of at least one aromatic vinyl or vinylidene monomer and at least one hindered aliphatic or cycloaliphatic vinyl or vinylidene monomer, and

(2) polymer units derived from at least one olefin selected from the group consisting of ethylene and C₃₋₂₀ α-olefins; and

(3) optionally polymer units derived from one or more of ethylenically unsaturated polymerizable monomers other than those derived from (1) and (2),

wherein the interpolymer backbone is grafted with at least one olefinically unsaturated organic monomer. In particular, the graft polymer is a graft substantially random interpolymer with a graft-modified backbone of one substantially random interpolymer. The invention further relates to blends of the novel graft polymers with at least one other olefin or non-olefin polymer, which itself can be grafted or non-grafted.

The invention also relates to melt processing techniques to produce the graft polymer, especially a reactive extrusion process, and hot melt grafting processes to produce these novel graft interpolymers.

Other aspects of the present the invention relate to uses of the novel graft interpolymers and fabricated articles made therefrom.

One embodiment of the present invention relates to a multilayer composite wherein at least one of the layers is composed of a graft interpolymer provided by the present invention, or a polymer blend comprising such graft interpolymer.

Another embodiment of the present invention pertains to fibers comprising graft substantially random interpolymer according to the invention, including fibers made of blends of the graft substantially random interpolymer with a polyolefin, and fabrics made from such fibers.

### DETAILED DESCRIPTION OF THE INVENTION

Definitions

All references herein to elements or metals belonging to a certain Group refer to the Periodic Table of the Elements published and copyrighted by CRC Press, Inc., 1989. Also any reference to the Group or Groups shall be to the Group or Groups as reflected in this Periodic Table of the Elements using the IUPAC system for numbering groups.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this document in a similar manner.

The term “copolymer” as employed herein means a polymer wherein at at least two different monomers are polymerized to form the copolymer.

The term “interpolymer” is used herein to indicate a polymer wherein at least two different monomers are polymerized to make the interpolymer. This includes copolymers, terpolymers, etc.

The term “reactive extrusion” herein refers to the performance of chemical reactions during continuous extrusion of polymers and/or polymerizable monomers. The reactants must be in a physical form suitable for extrusion processing. Reactions may be performed on molten polymers, on liquified monomers, or on polymers dissolved or suspended in or plasticized by solvent. Reactive extrusion refers to the performance of chemical reactions in a continuous extrusion process with short residence times. Detailed teachings relating to reactive extrusion are, for example, provided in “Reactive Extrusion—Principles and Practice” edited by M. Xanthos, Carl Hanser Verlag, Munich, Vienna, New York, Barcelona, 1992.

The term “derived from” means made or mixed from the specified materials, but not necessarily composed of a simple mixture of those materials. Compositions “derived from” specified materials may be simple mixtures of the original materials, and may also include the reaction products of those materials, or may even be wholly composed of reaction or decomposition products of the original materials. This includes, but is not limited to, those products “derived from” the grafted organic monomer or organic acid monomer. In the case of the grafted organic acid monomer, the acid moiety can, in the process of production, extrusion or fabrication, undergo one or more chemical reactions that might alter its structure. Specifically, the free carboxylic acid group can undergo reactions and be converted to an ester, or an anhydride, or acid salt. Likewise, when starting with the anhydride moiety, the anhydride can be converted to the free acid or an ester or an acid salt. One skilled in the art readily recognizes that these are common occurrences when thermally treating and handling organic acid grafted polymers. One skilled in the art would also recognize that, for example, a maleic anhydride moiety can exist as the original anhydride, the free maleic acid, an ester or a metal salt formed through the reaction with another component in the polymeric composition and understand that all these structures are included in this invention.

The term “comprising as used herein means “including”.

All parts and percentages are by weight unless indicated otherwise.

The term “substantially random” as used herein in reference to a substantially random interpolymer comprising polymer units derived from ethylene and/or one or more α-olefin monomers and polymer units derived from one or more vinyl or vinylidene aromatic monomers and/or aliphatic or cycloaliphatic vinyl or vinylidene monomers, and to ethylene/styrene interpolymers in particular, means that the distribution of the monomers of said interpolymer can be generally described by the Bernoulli statistical model or by a first or second order Markovian statistical model, as described by J. C. Randall in POLYMER SEQUENCE DETERMINATION, Carbon-13 NMR Method, Academic Press New York, 1977, pp. 71-78. Preferably, substantially random interpolymers do not contain more than 15 percent of the total amount of vinyl or vinylidene aromatic monomer in blocks of vinyl or vinylidene aromatic monomer of more than 3 units. More preferably, the interpolymer is not characterized by a high degree (greater than 50 mole percent) of either isotacticity or syndiotacticity. This means that in the carbon-13 NMR spectrum of the substantially random interpolymer the peak areas corresponding to the main chain methylene and methine carbons representing either meso diad sequences or racemic diad sequences should not exceed 75 percent of the total peak area of the main chain methylene and methine carbons.

Unless indicated otherwise the term “fiber” is used in a general sense and includes, without limitation, monofilaments, referring to individual strands of denier greater than 15, typically grater than 30; fine denier fibers or filaments, referring to strands of denier less than 15; multi-filaments, referring to simultaneously formed fine denier filaments spun in a bundle of fibers, generally containing at least 3 up to several thousand filaments; staple fibers, referring to fine denier strands which have been formed at, or cut to, staple lengths of typically 2.5 to 20 cm; fibrils, referring to super fine discrete filaments embedded in a more or less continuous matrix; multi-constituent fibers, such as bi-constituent fibers, referring to fibers comprising at least two polymers in continuous and/or dispersed phases; and multicomponent fibers, such as bicomponent fibers, referring to a fiber comprising two or more polymer components, each in a continuous phase, e.g. side by side or in a sheath/core arrangement.

The interpolymers used to prepare the novel graft interpolymers of the present invention include the substantially random interpolymers prepared by polymerizing i) ethylene and/or one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s).

Suitable α-olefins include, for example, α-olefins containing from 3 to about 20, preferably from 3 to about 12, more preferably from 3 to about 8 carbon atoms. Particularly suitable are ethylene, propylene, butene-1,4-methyl-1-pentene, hexene-1 or octene-1 or ethylene in combination with one or more of propylene, butene-1,4-methyl-1-pentene, hexene-1 or octene-1. These α-olefins do not contain an aromatic moiety.

Suitable vinyl or vinylidene aromatic monomers which can be employed to prepare the interpolymers include, for example, those represented by the following formula:

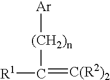

wherein R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to about 4, preferably from zero to 2, most preferably zero. Exemplary vinyl aromatic monomers include styrene, vinyl toluene, α-methylstyrene, t-butyl styrene, chlorostyrene, including all isomers of these compounds, and the like. Particularly suitable such monomers include styrene and lower alkyl- or halogen-substituted derivatives thereof. Preferred monomers include styrene, α-methyl styrene, the lower alkyl- (C₁-C₄) or phenyl-ring substituted derivatives of styrene, such as for example, ortho-, meta-, and para-methylstyrene, the ring halogenated styrenes, para-vinyl toluene or mixtures thereof, and the like. The most preferred aromatic vinyl monomer is styrene.

Suitable “hindered” aliphatic or cycloaliphatic vinyl or vinylidene monomers, are addition polymerizable vinyl or vinylidene monomers corresponding to the formula:

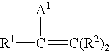

wherein A¹ is a hindered, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system.

The term “hindered” denotes that the monomer bearing this substituent is normally incapable of addition polymerization by standard Ziegler-Natta polymerization catalysts at a rate comparable with ethylene polymerizations. The term is used in the sense of “sterically bulky” or “sterically hindered”. Aliphatic α-olefins having a simple linear structure including, for example, propylene, butene-1,4-methyl-1-pentene, hexene-1 or octene-1 are not considered as hindered aliphatic or cycloaliphatic vinyl or vinylidene monomers.

Preferred aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl, norbornyl, and the like. Most preferred aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene.

If the substantially random interpolymer contains a vinyl or vinylidene aromatic monomer and a sterically hindered aliphatic or cycloaliphatic monomer in polymerized form, the weight ratio between these two monomer types is not critical. Preferably, the interpolymer comprises polymer units derived from either one or more vinyl or vinylidene aromatic monomers, or one or more hindered aliphatic or cycloaliphatic monomers. Vinyl or vinylidene aromatic monomers are preferred over hindered aliphatic or cycloaliphatic monomers.

Optional other polymerizable ethylenically unsaturated monomers include strained ring olefins such as norbornene and C₁-C₁₀ alkyl or C₆-C₁₀ aryl substituted norbornenes. Further, one or more dienes can optionally be incorporated into the interpolymer to provide functional sites of unsaturation on the interpolymer useful, for example, to participate in crosslinking reactions. While conjugated dienes such as butadiene, 1,3-pentadiene (that is, piperylene), or isoprene may be used for this purpose, nonconjugated dienes are preferred. Typical nonconjugated dienes include, for example the open-chain nonconjugated diolefins such as 1,4-hexadiene (see U.S. Pat. No. 2,933,480), 1,9-decadiene and 7-methyl-1,6-octadiene (also known as MOCD); cyclic dienes; bridged ring cyclic dienes, such as dicyclopentadiene (see U.S. Pat. No. 3,211,709); or alkylidene-norbornenes, such as methylenenorbornene or ethylidenenorbornene (see U.S. Pat. No. 3,151,173). The nonconjugated dienes are not limited to those having only two double bonds, but rather also include those having three or more double bonds. The diene may be incorporated in the substantially random interpolymer in an amount of from 0 to 15 weight percent based on the total weight of the interpolymer.

The substantially random interpolymers include the pseudo-random interpolymers as described in EP-A-0,416,815 by James C. Stevens et al. and in U.S. Pat. No. 5,703,187 by Francis J. Timmers, both of which are incorporated herein by reference in their entirety. The substantially random interpolymers also include the interpolymers of ethylene, one or more alpha-olefin monomers and at least one vinyl or vinylidene aromatic monomer as described in U.S. Pat. No. 5,872,201 by Yunwa W. Cheung et al., which is incorporated herein by reference in its entirety.

Due to the use of a catalyst system comprising a coordination complex having constrained geometry, interpolymers may be prepared that incorporate relatively bulky or hindered monomers in substantially random manner at low concentrations, and at higher concentrations according to an ordered insertion logic. The copolymers of ethylene or α-olefins and a hindered aliphatic vinyl or vinylidene monomer or a vinyl or vinylidene aromatic monomer are preferably described as “pseudo-random”. That is, the interpolymers lack well defined blocks of either monomer, however, the respective monomers are limited to insertion according to certain rules. These rules can be deduced from certain experimental details resulting from an analysis of the interpolymers, e.g. as follows: the polymers were analyzed by ¹³C-NMR spectroscopy at 130° C. with a Varian VXR-300 spectrometer at 75.4 MHz. Samples of 200 to 250 mg of interpolymer were dissolved in 15 ml of hot o-dichlorobenzene/1,1,2,2-tetrachloroethane-d₂ (approximately 70/30, v/v) which was approximately 0.05 M in chromium (III) tris(acetylacetonate)) and a portion of the resulting solution was added to a 10 mm NMR tube. The following parameters and conditions were used: spectral width, 16,500 Hz; acquisition time 0.090 s; pulse width, 36°; delay, 1.0 s with the decoupler gated off during the delay; FT size 32K; number of scans, >30,000; line broadening, 3 Hz. Spectra, as recorded were referenced to tetrachloroethane-d₂ (δ 73.77 ppm, TMS scale).

Therefore, without wishing to be bound by any particular theory, the results of the foregoing experimental procedures indicate that a particular distinguishing feature of pseudo-random copolymers is the fact that all phenyl or bulky hindering groups substituted on the polymer backbone are separated by 2 or more methylene units. In further explanation of the foregoing experimental and theoretical results, and without wishing to be bound by any particular theory it can be concluded that during the addition polymerization reaction employing the present catalysts, if a hindered monomer is inserted into the growing polymer chain, the next monomer inserted must be ethylene or a hindered monomer which is inserted in an inverted or “tail-to-tail” fashion. During the polymerization reaction, ethylene may be inserted at any time. After an inverted or “tail-to-tail” hindered monomer insertion, the next monomer must be ethylene, as the insertion of another hindered monomer at this point would place the hindering substituent closer together than the minimum separation as described above. A consequence of these polymerization rules is the catalysts used in this invention do not homopolymerize styrene to any appreciable extent, while a mixture of ethylene and styrene is rapidly polymerized and may give high styrene content (typically up to about 65 mole % styrene) copolymers.

The substantially random interpolymers can be prepared by polymerizing a mixture of polymerizable monomers in the presence of one or more metallocene or constrained geometry catalysts in combination with various cocatalysts. Preferred operating conditions for such polymerization reactions are pressures from atmospheric up to 3000 atmospheres and temperatures from −30° C. to 200° C.

Examples of suitable catalysts and methods for preparing the substantially random interpolymers are disclosed in U.S. application Ser. No. 702,475, filed May 20, 1991 (EP-A-514,828); as well as U.S. Pat. Nos. 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; and 5,721,185, all of which patents and applications are incorporated herein by reference.

The substantially random α-olefin/vinyl aromatic interpolymers can also be prepared by the methods described in JP 07/278,230 employing compounds shown by the general formula

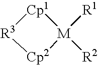

wherein Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to cross-link Cp¹² and Cp².

The substantially random α-olefin/vinyl aromatic interpolymers can also be prepared by the methods described by John G. Bradfute et al. (W. R. Grace & Co.) in WO 95/32095; by R. B. Pannell (Exxon Chemical Patents, Inc.) in WO 94/00500; and in Plastics Technology, p. 25 (September 1992), all of which are incorporated herein by reference in their entirety.

Also suitable are the substantially random interpolymers which comprise at least one α-olefin/vinyl aromatic/vinyl aromatic/α-olefin tetrad disclosed in WO-A-98/09999 by Francis J. Timmers et al. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons. It is believed that these new signals are due to sequences involving two head-to-tail vinyl aromatic monomer insertions preceded and followed by at least one α-olefin insertion, e.g. an ethylene/styrene/styrene/ethylene tetrad wherein the styrene monomer insertions of said tetrads occur exclusively in a 1,2 (head to tail) manner. It is understood by one skilled in the art that for such tetrads involving a vinyl aromatic monomer other than styrene and an α-olefin other than ethylene that the ethylene/vinyl aromatic monomer/vinyl aromatic monomer/ethylene tetrad will give rise to similar carbon-13 NMR peaks but with slightly different chemical shifts.

These interpolymers can be prepared by conducting the polymerization at temperatures of from about −30° C. to about 250° C. in the presence of such catalysts as those represented by the formula

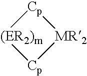

wherein: each Cp is independently, each occurrence, a substituted cyclopentadienyl group π-bound to M; E is C or Si; M is a group IV metal, preferably Zr, Ti or Hf, most preferably Zr; each R is independently, each occurrence, H, hydrocarbyl, silahydrocarbyl, or hydrocarbylsilyl, containing up to about 30 preferably from 1 to about 20 more preferably from 1 to about 10 carbon or silicon atoms; each R′ is independently, each occurrence, H, halo, hydrocarbyl, hyrocarbyloxy, silahydrocarbyl, hydrocarbylsilyl containing up to about 30 preferably from 1 to about 20 more preferably from 1 to about 10 carbon or silicon atoms or two R′ groups together can be a C₁₀-C₁₀ hydrocarbyl substituted 1,3-butadiene; m is 1 or 2; and optionally, but preferably in the presence of an activating cocatalyst. Particularly, suitable substituted cyclopentadienyl groups include those illustrated by the formula:

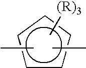

wherein each R is independently, each occurrence, H, hydrocarbyl, silahydrocarbyl, or hydrocarbylsilyl, containing up to about 30 preferably from 1 to about 20 more preferably from 1 to about 10 carbon or silicon atoms or two R groups together form a divalent derivative of such group. Preferably, R independently each occurrence is (including where appropriate all isomers) hydrogen, methyl, ethyl, propyl, butyl, pentyl, hexyl, benzyl, phenyl or silyl or (where appropriate) two such R groups are linked together forming a fused ring system such as indenyl, fluorenyl, tetrahydroindenyl, tetrahydrofluorenyl, or octahydrofluorenyl.

Particularly preferred catalysts include, for example, racemic-(dimethylsilanediyl)-bis-(2-methyl-4-phenylindenyl) zirconium dichloride, racemic-(dimethylsilanediyl)-bis-(2-methyl-4-phenylindenyl) zirconium 1,4-diphenyl-1,3-butadiene, racemic-(dimethylsilanediyl)-bis-(2-methyl-4-phenylindenyl) zirconium di-C1-4 alkyl, racemic-(dimethylsilanediyl)-bis-(2-methyl-4-phenylindenyl) zirconium di-C₁₋₄ alkoxide, or any combination thereof and the like.

It is also possible to use the following titanium-based constrained geometry catalysts, [N-(1,1-dimethylethyl)-1,1-dimethyl-1-[(1,2,3,4,5-η)-1,5,6,7-tetrahydro-s-indacen-1-yl]silanaminato(2-)-N]titanium dimethyl; (1-indenyl)(tert-butylamido) dimethyl-silane titanium dimethyl; ((3-tert-butyl)(1,2,3,4,5-η)-1-indenyl)(tert-butylamido) dimethylsilane titanium dimethyl; and ((3-iso-propyl)(1,2,3,4,5-η)-1-indenyl)(tert-butyl amido)dimethylsilane titanium dimethyl, or any combination thereof and the like.

Further preparative methods for the interpolymers used in the present invention have been described in the literature. Longo and Grassi (Makromol. Chem., Volume 191, pages 2387 to 2396 [1990]) and D'Anniello et al. (Journal of Applied Polymer Science, Volume 58, pages 1701-1706 [1995]) reported the use of a catalytic system based on methylalumoxane (MAO) and cyclopentadienyltitanium trichloride (CpTiCl₃) to prepare an ethylene-styrene copolymer. Xu and Lin (Polymer Preprints, Am. Chem. Soc., Div. Polym. Chem.) Volume 35, pages 686,687 [1994]) have reported copolymerization using a MgCl₂/TiCl₄/NdCl₃/Al(iBu)₃ catalyst to give random copolymers of styrene and propylene. Lu et al (Journal of Applied Polymer Science, Volume 53, pages 1453 to 1460 [1994]) have described the copolymerization of ethylene and styrene using a TiCl₄/NdCl₃/MgCl₂/Al(Et)₃ catalyst. Sernetz and Mulhaupt, (Macromol. Chem. Phys., v. 197, pp. 1071-1083, 1997) have described the influence of polymerization conditions on the copolymerization of styrene with ethylene using Me₂Si(Me₄Cp)(N-tert-butyl)TiCl₂/methylaluminoxane Ziegler-Natta catalysts. Preparative methods for the copolymers of ethylene and styrene produced by bridged metallocene catalysts include those described by Arai, Toshiaki and Suzuki (Polymer Preprints, Am. Chem. Soc., Div. Polym. Chem.) Volume 38, pages 349, 350 [1997]), or as disclosed in DE-A-197 11 339 to Denki Kagaku Kogyo KK, and also as disclosed in U.S. Pat. No. 5,652,315, issued to Mitsui Toatsu Chemicals, Inc. The manufacture of α-olefin/vinyl aromatic monomer interpolymers such as propylene/styrene and butene/styrene are described in U.S. Pat. No. 5,244,996, issued to Mitsui Petrochemical Industries Ltd. All the above methods disclosed for preparing the interpolymer component are incorporated herein by reference. Also, the copolymers of ethylene and styrene as disclosed in Polymer Preprints Vol 39, No. 1, March 1998 by Toru Aria et al. can also be employed for the purposes of the present invention.

While preparing the substantially random interpolymer, an amount of atactic vinyl aromatic homopolymer may be formed due to homopolymerization of the vinyl aromatic monomer at elevated temperatures. The presence of vinyl aromatic homopolymer is, in general, not detrimental for the purposes of the present invention and can be tolerated. The vinyl aromatic homopolymer may be separated from the interpolymer, if desired, by extraction techniques such as selective precipitation from solution with a non solvent for either the interpolymer or the vinyl aromatic homopolymer. For the purpose of the present invention it is preferred that no more than 30 weight percent, preferably less than 20 weight percent based on the total weight of the interpolymers of atactic vinyl aromatic homopolymer is present.

A preferred graft substantially random interpolymer comprises the backbone of one or more, preferably one, substantially random interpolymer comprising

(1) polymer units derived from

(a) at least one vinyl or vinylidene aromatic monomer, or

(c) a combination of at least one aromatic vinyl or vinylidene monomer and at least one hindered aliphatic or cycloaliphatic vinyl or vinylidene monomer, and

(2) polymer units derived from at least one of ethylene and/or a C₃₋₂₀ α-olefin; and

(3) optionally polymer units derived one or more of ethylenically unsaturated polymerizable monomers other than those derived from (1) or (2);

said backbone being grafted with one or more of ethylenically unsaturated organic monomers.

A graft polymer according to the present invention comprises, preferably consists essentially of, the graft-modified backbone of one substantially random interpolymer having a melt index (I₂) of at least 0.01, preferably in the range of from about 0.01 to about 1000, more preferably from about 0.01 to about 50 g/10 min, and a molecular weight distribution (as reflected in the ratio of the weight average molecular weight and the number average molecular weight; M_{w}/Mₙ) of from about 1.5 to about 20, comprising

(1) polymer units derived from

(a) at least one vinyl or vinylidene aromatic monomer, or

(b) at least one hindered aliphatic or cycloaliphatic vinyl or vinylidene monomer, or

(c) a combination of at least one aromatic vinyl or vinylidene monomer and at least one hindered aliphatic or cyclophatic vinyl or vinylidene monomer, and

(2) polymer units derived from at least one of ethylene and/or a C₃₋₂₀ α-olefin; and

(3) optionally polymer units derived one or more of ethylenically unsaturated polymerizable monomers other than those derived from (1) or (2);

said backbone being grafted with one or more of an olefinically unsaturated organic monomer, preferably an ethylenically unsatured organic acid monomer. The melt index of the graft-modified substantially random interpolymer is selected such that said interpolymer meets the needs of the desired end use application. Such selection is routine for the person skilled in the art. The melt index (I₂) is determined by ASTM D-1238, condition 190° C./2.16 kg.

A further preferred graft polymer according to the invention comprises a backbone of a one or more, preferably one, substantially random interpolymers having an I₂ of about 0.01 to about 50 g/10 min, an M_{W}/Mₙ of about 1.5 to about 20, comprising

(1) from about 1 to about 65 mole percent, preferably from 8 to 65 mole percent of polymer units derived from,

(a) at least one vinyl or vinylidene aromatic monomer, or

(b) at least one hindered aliphatic or cyclophatic vinyl or vinylidene monomer, or

(c) a combination of at least one aromatic vinyl or vinylidene monomer and at least one hindered aliphatic or cyclophatic vinyl or vinylidene monomer, and

(2) from about 35 to about 99 mole percent, preferably from 35 to 92 mole percent, of polymer units derived from at least one of ethylene and/or a C₃₋₂₀ α-olefin, and

(3) from 0 to 20 mole percent of polymer units derived from one or more of ethylenically unsaturated polymerizable monomers other than those derived from (1) and (2),

said backbone being grafted with one or more olefinically unsaturated organic monomer(s).

Further preferred graft polymers according to the invention are those, wherein said graft-modified substantially random interpolymer has an M_{w}/Mₙ of about 1.5 to about 20 and comprises

(1) from about 5 to about 50, preferably from about 10 to about 43 mole % of polymer units derived from

(a) a vinyl or vinylidene aromatic monomer represented by the following formula

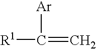

wherein R¹ is selected from the group of radicals consisting of hydrogen and alkyl radicals containing three carbons or less, and Ar is a phenyl group or a phenyl group substituted with from 1 to 5 substituents selected from the group consisting of halo, C₁-C₄-alkyl, and C₁₋₄-haloalkyl, or

(b) a hindered aliphatic or cycloaliphatic vinyl or vinylidene monomer is represented by the following general formula

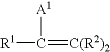

wherein A¹ is a sterically bulky, aliphatic or cyclophatic substituent of up to 20 carbons, R¹ is selected from the group of radicals consisting of hydrogen and alkyl radicals containing from 1 to about 4 carbon atoms, preferably hydrogen or methyl, each R² is independently selected from the group of radicals consisting of hydrogen and alkyl radicals containing from 1 to 4 carbon atoms, preferably hydrogen or methyl, or alternatively R¹ and A¹ together from a ring system, or

(c) a combination of (a) and (b), and

(2) from about 50 to about 95 mole %, preferably from about 57 to about 90 mole %, of polymer units derived from ethylene and/or an α-olefin selected from the group consisting of at least one of propylene, 4-methyl-1-pentene, butene-1, hexene-1 or octene-1, and

(3) from 0 to about 20 mole percent of said ethylenically unsaturated polymerizable monomer other than those derived from (1) and (2) which is selected from the group consisting of norbonene, or a C₁-C₁₀ alkyl or C₆-C₁₀ aryl substituted norbornene.

A further preferred embodiment of the present invention is a graft polymer wherein said substantially random interpolymer has an M_{W}/Mₙ from about 1.8 to about 20 and comprises

(1) from about 13 to about 40 mole % of polymer units derived from

(a) said vinyl or vinylidene aromatic monomer which comprises styrene, α-methyl styrene, ortho-, meta-, and para-methylstyrene, and the ring halogenated styrenes, or

(b) said aliphatic or cycloaliphatic vinyl or vinylidene monomers which comprises 5-ethylidene-2-norbornene or 1-vinylcyclo-hexene, 3-vinylcyclo-hexene, and 4-vinylcyclohexene, or

(c) a combination of a and b, and

(2) from about 60 to about 87 mole % of polymer units derived from ethylene, or ethylene and said α-olefin, which comprises ethylene, or ethylene and at least one or propylene, 4-methyl-1-pentene, butene-1, hexene-1 or octene-1, and

(3) said ethylenically unsaturated polymerizable monomers other than those derived from (1) and (2) is norbornene.

The most preferred graft polymers according to the invention are those, wherein the graft-modified backbone is a substantially random interpolymer comprising one or more vinyl aromatic monomers in combination with ethylene or a combination of ethylene and one or more C₃-C₈ alpha olefin monomers, or a combination of ethylene and norbornene. Such interpolymers include the substantially random interpolymers selected from the group consisting of ethylene/styrene, ethylene/propylene/styrene, ethylene/butene/styrene, ethylene/pentene/styrene, ethylene/hexene/styrene, or ethylene/octene/styrene.

To obtain the graft polymers of the invention, one or more of the substantially random interpolymers are chemically modified, with an olefinically unsaturated monomer, e.g. a vinyl-containing reactive monomer, or a mixture of such monomers, preferably in a free-radical grafting reaction. The graft-modification introduces (additional) functional groups on the interpolymer backbone. Olefinically unsaturated organic monomers suitable for the preparation of the graft polymers of the invention include any unsaturated organic compound which comprises at least one ethylenic unsaturation (e.g., at least one double bond) and at least one carbonyl group (—C═O) (which carbonyl group may be part of a carboxyl group), and which—under suitable conditions—is capable of grafting to the backbone of a substantially random interpolymer as defined above. Representative of such olefinically unsaturated organic monomers that contain at least one carbonyl group are organic carboxylic acids, including monocarboxylic acids and dicarboxylic acids, their anhydrides, esters and salts, both metallic and nonmetallic. Preferably, the olefinically unsaturated organic monomer is characterized by at least one ethylenic unsaturation conjugated with a carbonyl group. Preferred organic monomers include maleic acid, fumaric acid, acrylic acid, methacrylic acid, itaconic acid, crotonic acid, alpha-methyl crotonic acid and cinnamic acid and their anhydride, ester and salt derivatives. Acrylic acid, maleic acid and maleic anhydride are the more preferred olefinically unsaturated organic monomers containing at least one ethylenic unsaturation and at least one carbonyl group, maleic anhydride being the most preferred monomer.

In accordance with the present invention it is possible to use a single monomer species for grafting, however, the use of two or more different graft monomers is also possible. In an especially preferred embodiment of the invention the interpolymer backbone is grafted with maleic anhydride. Thus an especially preferred interpolymer of the invention is a maleic anhydride (MAH) grafted ethylene/styrene interpolymer or a maleic anhydride grafted ethylene/C₃-C₈ alpha-olefin/styrene interpolymer.

Advantageously, a peroxide or other free radical initiator is used to accelerate the grafting. Suitable peroxides include, but are not limited to, aromatic diacyl peroxides; aliphatic diacyl peroxides; dibasic acid peroxides; ketone peroxides; alkyl peroxyesters; alkyl hydroperoxides; alkyl and dialkyl peroxides, such as diacetylperoxide, 2,5-bis (t-butylperoxy)-2,5-dimethylhexane or 2,5-dimethyl-2,5di(t-butylperoxy)hexyne-3.

Grafting of the substantially random interpolymer backbone with the olefinically unsaturated organic monomer can be achieved reactive extrusion in the melt, by reaction with the solid state polymer, or in solutio. The methods as described in U.S. Pat. Nos. 3,236,917; 4,762,890 and 5,194,509 are incorporated herein by reference. The grafting reaction is free radical initiated, the free radicals being generated by UV, chemical or other techniques. Details of the grafting reaction are given in the above US patents, which are relied upon for further teaching. The grafting process may also be a solid phase grafting process.

For example, in U.S. Pat. No. 3,236,917 the polymer is introduced into a two-roll mixer and mixed at a temperature of 60° C. The unsaturated organic compound is then added along with a free radical initiator, such as, for example, benzoyl peroxide, and the components are mixed at 30° C. until the grafting is completed. In U.S. Pat. No. 5,194,509, the procedure is similar except that the reaction temperature is higher, e.g. 210 to 300° C., and a free radical initiator is not used or is used at a reduced concentration.

An alternative and preferred method for grafting is taught in U.S. Pat. No. 4,950,541, the disclosure of which is incorporated into and made a part of this application by reference. According to this preferred method, the substantially random interpolymer and the olefinically unsaturated organic monomer are mixed and reacted within at suitable device, e.g. an extruder, such as a twin-screw devolatilizing extruder, at temperatures at which the reactants are molten or in liquid form and in the presence of a free radical initiator. The unsaturated organic monomer may be mixed and dissolved in a non-reactive solvent known in the art. Preferably, the unsaturated organic monomer is injected into a zone maintained under pressure within the extruder.

According to the present invention it is preferred that the graft polymers according to the invention are prepared by melt processing technology, especially in the temperature range of about 50° C. to about 300° C. This melt processing technology can be a batch-wise or a continuous melt processing technology. In an especially preferred embodiment of the present invention a reactive extrusion technology is used. Graft interpolymers which are prepared by the above melt processing techniques are therefore preferred subjects of the present invention.

Using the preferred preparative methods, the substantially random graft interpolymers of the present invention are surprisingly found not to change, or not to change significantly, in molecular weight or molecular weight distribution upon or following their reactive extrusion or melt processing transformation. The relative stability of the interpolymer molecular weight, as compared, e.g., to analogously grafted HDPE or LLDPE polymers, is reflected, for example, in the substantially unchanged melt index of the substantially random graft interpolymer. As compared to the starting non-graft interpolymer the melt index of the resulting graft interpolymer remains substantially the same or, if at all, decreases only relatively slightly (depending on the graft content of the interpolymer). Advantageously, the grafting process and conditions are selected and controlled such that the functional groups are introduced into the interpolymer via reaction with the olefinically unsaturated monomer without any or at least without any significant degree of crosslinking or scission of the polymer backbone. These effects can easily be monitored by comparing melt indices of the non-grafted and grafted interpolymers. Most or all of the physical and/or mechanical properties of the substantailly random interpolymer are maintained. These improvements over the prior art graft polymers manifest their advantages e.g. in the lack of or significant decrease in gel formation and/or in the lack (or reduction) of increase in flow rate as well as improved strength, impact, thermal properties and processability.

However, under some conditions, the grafting process may induce changes in the molecular weight and molecular weight distribution of the grafted interpolymer. One skilled in the art readily recognizes if these changes affect the desired performance of the grafted interpolymer and react accordingly. Although it is advantageous and preferred in the present invention that no significant change in molecular weight of the interpolymer occurs as a result of the graft process, there are some circumstances when change in molecular weight is useful for the desired application. Graft interpolymers which change molecular weight during the grafting process are therefore also the subject of this invention.

A preferred process for preparing the substantially random graft interpolymers according to the invention is a reactive extrusion process which satisfies the following conditions:

Equipment: Any single or multiple screw, e.g. twin screw, extruder or any melting/hot melting mixing device capable of allowing the temperature and time (duration) of the process to be controlled and capable of allowing the addition of solid or liquid components as desired.

Temperature: The temperature of the process must at some point be such that it is greater than the melting point of the interpolymer; or, if the interpolymer is amorphous, some temperature such that the interpolymer can be processed easily and without shear degradation on the equipment used. The temperature of the process must be such that it is above the initiation-temperature of the peroxide being used, but not so high that total decomposition of peroxide occurs before it is sufficiently mixed with the other components.

Time: The duration of the process should be such that it allows sufficient melt-mixing of all the reaction components, and greater than the time required to allow for 90-99% complete decomposition of the peroxide being used (this time can be calculated from the half-life characteristics of the peroxide being employed). One of skill in the art can readily assess, without undo experimentation, the appropriate conditions for the reactive extrusion process of this invention.

Feed Components: The components added in the reactive extrusion process can be added in any of the following three ways: (1) the three components are added separately, with the substantially random interpolymer being added first, then the vinyl acid (VA), i.e. the olefinically unsaturated monomer, and finally the peroxide (ROOR); (2) the interpolymer is added first, then a mixture of the peroxide and the vinyl acid; and (3) all three components can be added together.

Composition:

| General: | Interpolymer | 99.94 wt %-85 wt % | |
|---|---|---|---|
| | Vinyl Acid (VA) | 0.05 wt %-10 wt % | |
| | Peroxide (ROOR) | 0.01 wt %-5 wt % | |
| | VA/ROOR | 10/1-1/1 | (wt/wt) |
| | VA/ROOR | 10/1-1/10 | (moles/moles) |
| Preferred: | Interpolymer | 99.9 wt %-97 wt % | |
| | Vinyl Acid | 0.05 wt %-2 wt % | |
| | Peroxide | 0.05 wt %-1 wt % | |
| | VA/ROOR | 10/1-1/1 | (wt/wt) |
| | VA/ROOR | 10/1-1/1 | (moles/moles). |

For the above preferred conditions, interpolymer denotes any substantially random interpolymers as defined herein, preferably those designated as preferred, e.g. ethylene/styrene interpolymer, ethylene/alpha-olefin/styrene interpolymer, blends of substantially random interpolymers, e.g. blends of ethylene/styrene interpolymers with ethylene/α-olefin copolymers. This also comprises hydrogenated and partially hydrogenated random styrene/butadiene (SB) rubbers. Vinyl acid includes, for example, any substituted or non-substituted, carboxylic acid or ester moiety containing a polymerizable double bond. This comprises, but is not limited to maleic acid or ester, fumaric acid or ester, and the like. Peroxide is meant to encompass any organoperoxide compound. This comprises, but is not limited to, dicumyl peroxide, benzoyl peroxide, and the like. For the purpose of the invention, any free radical initiator can be employed, such as an azocompound.

Since, using the preferred process for the preparation of the grafted interpolymers of the invention, products can be obtained, that show improved strength, appearance and other beneficial properties, e.g. those mentioned above, a substantially random graft interpolymer which is produced by a hot melting process, and especially a reactive extrusion process, is another subject of the present invention (including polymer compositions comprising such interpolymer). The present invention also relates to a graft polymer composition comprising the reaction product of a (backbone) substantially random interpolymer and an olefinically unsaturated organic monomer, for example maleic acid or maleic acid anhydride, in the presence of a free radical initiator, preferably a peroxide, characterized in that the reaction product contains more than about 0.1 weight percent, preferably more than about 0.5 weight percent to about 2 weight percent or more of the organic monomer (in covalently bonded form) along the interpolymer backbone, for example as succinic acid or succinic acid groups.

In one embodiment, the novel substantially random graft interpolymers of the invention are used as compatibilizers for filled resinous products. Many molded and extruded products contain fillers, e.g., silica, talc, glass, clay, carbon black, and the like, e.g. to enhance strength and/or provide for another desirable property. Often these fillers are only marginally compatible with the resinous matrix within which they are incorporated and as such, the amount of filler which can be incorporated into the matrix, i.e., the loading level, is limited. Compatibilizers are used to coat or otherwise treat the filler to render it more compatible with the matrix, and thus allow a high loading to be achieved. The graft-modified substantially random interpolymers of this invention are particularly desirable compatibilizers because higher loading levels can be achieved, i.e. either more filler can be incorporated into a given resin matrix based on the amount of compatibilizer, or less compatibilizer is required to incorporate the same amount of filler. In addition, the compatibilizers of this invention impart desirable properties to the composition in both fabricated and pre-fabricated form. In fabricated form, the strength and impact properties are enhanced relative to fabricated compositions void of grafted substantially random polymer. In pre-fabricated form, for example pellet, sheet, uncured packaging etc., the processability of the compositions by batch or continuous methods is enhanced relative to compositions void of grafted substantially random polymer of the invention.

The lack of or significant reduction in gel formation in graft substantially random interpolymers according to this invention leads to final products with excellent appearance, particularly visual appearance, and transparency making them well suited for packaging and especially for food packaging applications. Also for other purposes the advantages of no or significantly reduced gel formation and lack of substantial increase (or decrease) in flow rate are evident.

The graft interpolymer of the invention can also be used as a chemical coupling agent for thermoplast-fiberglass composites as a result of its improved adhesive properties to polar polymers or as self adherent polymeric coating material. Such coating material can be applied, for example, to metal or other surfaces; another possibility is its use as primer component or as hot melt adhesive.

Applications where the grafted substantially random interpolymers of the present invention are useful include, but are not limited to: flooring systems, for example to improve filler bonding and durability; carpet structures, for example to provide improved bonding between components such as fibers based on polyethylene terephthalate, polyamide and polypropylene, improved bonding to substrates and in the event of recycling, improved compatibility between carpet components; construction, including glazing systems, as a concrete additive, wall covering etc.; wire and cable systems, particularly those including fillers; multilayer container and film structures, and particularly those which impart a controlled atmosphere to packaged goods and food products, e.g. film structures including polar polymer such as ethylene/vinyl acetate, ethylene/vinyl alcohol, ethylene/acrylate, polyamides and polyvinylidene chloride homo- or co-polymers; paintable/printable polyolefin structures such as films, sheets and molded articles; laminated structures for fluid containment such as fuel tanks and piping systems; polymer bound additives; bitumen compositions; laminated structures including a scrim material such as nylon or PET for e.g. artificial leather or tarpaulins; sound and vibration management systems; binders for fabrics and fibrous structures; paint, adhesive and caulking compositions; metal laminates for surface protection against damage or corrosion for example to chemicals and abrasive materials; foams, and composite foam structures; steel pipe coatings and adhesives; adhesive layers between woven polyamide; adhesives for bicomponent fibers of polyolefins, polyethylene terephthalate, and interpolymers; compatibilizers for recycle polymeric compositions.

Blends of substantially random graft interpolymers of the present invention with other polymers are a further subject of the present invention. The interpolymers according to the present invention are further particularly useful in blends with one or more olefin or non-olefin polymers, which themselves may be grafted or non-grafted. Examples for such polymers are nylon, polycarbonate, polyethylene and copolymers, polypropylene and copolymers, polystyrene and styrenic copolymers, SB— and other rubbers, etc. In a preferred embodiment, the graft-modified substantially random interpolymer is dry blended or melt blended with another thermoplastic polymer, and then molded or extruded into a shaped article. Such other thermoplastic polymers include any polymer with which the grafted substantially random polymer is compatible, and include both olefins and non-olefin polymers, grafted and ungrafted. Examples of such polymers include high density polyethylene (HDPE), low density polyethylene (LDPE), linear low density polyethylene (LLDPE), ultra low density polyethylene (ULDPE), polypropylene, ethylene-propylene copolymer, ethylene-styrene copolymer, polyisobutylene, ethylene-propylene, thylene-propylene-diene monomer (EPDM) copolymer, polystyrene, styrene-acrylonitrile (SAN) colopymer, styrene-maleic anhydride (SMA) copolymer, acrylonitrile-butadiene-styrene (ABS) copolymer, ethylene/acrylic acid (EAA), ethylene/vinyl acetate (EVA), ethylene/vinyl alcohol (EVOH), polymers of ethylene and carbon monoxide (ECO), including those described in U.S. Pat. No. 4,916,208, or ethylene, propylene and carbon monoxide (EPCO) polymers, or ethylene, carbon monoxide and acrylic acid (ECOAA) polymers, and the like. Representative of the non-olefin polymers are the polyesters, polyvinyl chloride (PVC), epoxides, polyurethanes, polycarbonates, polyamides, and the like.

Suitable polyamides which can be employed herein include those prepared both by condensation and ring opening polymerization. These are often given the common name Nylon. Suitable materials include, for example, nylon 6, nylon 11, and nylon 12. Polyamides are also prepared by condensation methods, such as the reaction between a diamine and a diacid (or diacid derivative). The structure of materials prepared by this method are designated numerically with the number of carbons between the nitrogen atoms from the diamine portion followed by the number of carbon atoms in the diacid portion. For example, the polymer prepared from 1,6-diamino hexane and adipic acid is described as polyamide 66 or nylon 66. Condensation polyamides include, for example, polyamides 46, 66, 69, 610, and 612. Blends of polyamides and MAH-grafted substantially random interpolymers provide particularly advantageous performance properties.

Blends of substantially random graft interpolymers of the present invention with other polymers preferably comprise from about 0.1 to about 99.9 weight percent of one or more additional polymeric component, based on the total weight of the composition, Preferred additional polymeric components are polyethylene homopolymer or copolymers or polypropylene homopolymer or copolymers, and polyamides, e.g. nylons. The blends of this invention also include those composite systems comprising at least two dissimilar polymers in combination with one or more substantially random graft interpolymers, and in which the substantially random graft interpolymers act as a compatibilizer. Such multicomponent systems employ the substantially random graft interpolymers preferably in amounts of from about 2 to about 30 weight percent.

Such blends can also be advantageously used for packaging purposes including food and industrial packaging and other uses taking advantage of the improved properties of the polymer blends, such uses being well known to one skilled in the art.

The graft substantially random interpolymers or blends of such graft interpolymers according to the present invention are further particularly useful in compositions with one or more fillers, e.g. compositions containing up to 95 weight percent of one or more fillers. Many molded and extruded products contain fillers, e.g., silica, talc, glass, clay, carbon black, and the like, e.g. to enhance strength and/or provide for another desirable property. The graft-modified substantially random interpolymers of this invention are particularly desirable components of composite systems, imparting desirable properties to the composition in both fabricated and pre-fabricated form, by providing enhanced bonding between the fillers and the polymer matrix comprising the graft-modified substantially random interpolymers. Examples of such fillers are glass, glass fibers, talc, calcium carbonate, clay, carbon black, marble dust, cement dust, feldspar, silica, fumed silica, silicates, alumina, magnesium, oxide, antimony oxide, zinc oxide, barium sulfate, aluminium silicate, calcium silicate, titanium oxides, glass microspheres, mica, clays, wollastaone and chalk, magnesium hydroxide, calcium hydroxide and aluminum trihydrate and the like. Compositions of graft interpolymers or blends of interpolymers of the present invention with fillers and especially with fillers in an amount of 10 to 90 percent by weight of the composition, therefore, are a further subject of the present invention.

Still a further subject of the present invention are multilayer composites containing at least one layer of the graft substantially random interpolymer or a blend of interpolymers of the present invention.

In such multilayer composites it is possible to combine layers of materials that cannot readily be combined otherwise or only by use of other substances that might not be desirable in a final product. The graft interpolymer of the present provides enhanced adhesion or compatibility between the different layers of the multilayer structure. For example, it is possible to combine layers of polyethylene with layers of polar materials, as for example nylon or ethylene vinyl alcohol, using an intermediate layer of a graft polymer according to the invention. The graft polymer combines properties of polar and nonpolar polymers and, hence, allows formation of an improved performance film or multilayer structures.

The materials of the present invention may contain one or more additives, for example, antioxidants (e.g. hindered phenols such as, for example, Irganox™ 1010, a registered trademark of Ciba Geigy), phosphites (e.g., Irgafos™ 168 a registered trademark of Ciba Geigy), U.V. stabilizers, cling additives (e.g., light stabilizers, such as hindered amines; plasticizers, such as dioctylphthalate or epoxidized soy bean oil; thermal stabilizers; mold release agents tackifiers, such as hydrocarbon tackifiers; waxes, such as polyethylene waxes; processing aids, such as oils, organic acids such as stearic acid, metal salts of organic acids; crosslinking agents, such as peroxides or silanes; colorants or pigments to the extent that they do not interfere with the desired physical or mechanical properties of the compositions of the present invention. The above additives are employed in functionally equivalent amounts known to those skilled in the art, generally in amounts of up to about 30, preferably from about 0.01 to about 5, more preferably from about 0.02 to about 1 percent by weight, based upon the total weight of the composition.

The graft polymers, blends of polymers or multilayer composites of the present invention can be processed to fabricated articles by any suitable means known in the art. For example, they can be processed to films or sheets or to one or more layers of a multilayered structure by known processes, such as calendering, blowing, casting or extrusion including co-extrusion processes. Injection molded, compression molded, extruded or blow molded parts can also be prepared from the compositions of the present invention. Alternatively, the compositions can be processed to foams or fibers. Useful temperatures for processing the interpolymer(s) in combination with the filler(s) and optional additives to the fabricated articles generally are 100° C. to 300° C., preferably from 120° C. to 250° C., more preferably from 140° C. to 200° C.

Such fabricated articles of the present invention may also be foamed. The foam layer may be produced by an extrusion process or from expandable or foamable particles, moldable foam particles, or beads from which a sheet is formed by expansion and/or coalescing and welding of those particles. Various additives may be incorporated in the foam structure, such as stability control agents, nucleating agents, pigments, antioxidants, acid scavengers, ultraviolet absorbers, flame retardants, processing aids or extrusion aids. Some of the additives are described in more detail above.

The grafted interpolymers and grafted interpolymer blends and compositions, in the present invention may be crosslinked chemically or with radiation. Suitable free radical crosslinking agents include organic peroxides such as dicumyl peroxide, hydrolyzed silanes, organic azides, or a combination thereof. Alternatively, the grafted interpolymer or interpolymer blend or composition may be crosslinked via a process of the separate grafting of a silane moiety to the backbone followed by hydrolysis of the silane to form crosslinks between adjacent polymer chains via siloxane linkages.

The graft polymers or blends of polymers of the present invention can readily be coated, extruded, or layered onto a substrate. Typical substrates include glass, metal, ceramic, wood, polymer-based materials, natural fibers, matting, and mixtures thereof. Alternatively the materials of the present invention can be extruded, milled, or calendered as unsupported films or sheets, for example for producing floor tiles, wall tiles, floor sheeting, wall coverings, or ceiling coverings. They are particularly useful as sound insulating or energy absorbing layers, films, sheets or boards. Films, sheets or boards of a wide thickness range can be produced. Depending on the intended end-use, useful thicknesses generally are from 0.5 to 20 mm, preferably from 1 to 10 mm. Alternatively, injection molded parts or blow molded articles, such as toys, containers, building and construction materials, automotive components, and other durable goods can be produced from the compositions of the present invention.

It has also been found that fibers comprising the novel graft substantially random interpolymers particularly benefit from the improved properties of such interpolymers, e.g. by means of improved processability and higher productivity in the fiber forming processes, e.g. in the fiber spinning process (as compared to conventional fibers comprising graft polyolefin instead of graft substantially random interpolymer). Advantageously used in fibers are such graft substantially random interpolymers which show no or only minimal levels of cross-linked or higher molecular weight interpolymer as a result of the graft modification. Such interpolymers are characterized in that their melt index does not significantly change (decrease) as a result of the graft modification.

In a preferred embodiment, the present invention provides fibers comprising the above defined graft substantially random interpolymers, in particular those indicated as being preferred. Especially preferred are fibers comprising such substantially random interpolymers grafted with an ethylenically unsaturated carboxylic acid or its anhydride, preferably a dicarboxylic acid or a monocarboxylic acid, or an anhydride thereof, more preferably maleic acid or maleic anhydride. Grafting with maleic acid or maleic anhydride gives rise to succinic acid groups or succinic anhydride groups along the interpolymer backbone, preferably with no or only minimal side reactions, such as crosslinking or chain scission. Preferred are graft substantially random interpolymers having a melt index of at least about 5 or higher, preferably at least about 10 or higher, and is not significantly lower than the melt index of the substantially random interpolymer before grafting. Advantageously, the content of the functional group or groups, e.g. succinic acid groups and/or succinic anhydride groups, introduced in the grafting process is at least about 0.1, preferably at least about 0.5, more preferably at least about 1 weight percent of the graft substantially random interpolymer. The content of residual (free) olefinically unsaturated organic monomer in the interpolymer should be as low as possible.

The fibers of the invention can be prepared using known fiber forming technologies, e.g. melt spinning. In this procedure, the molten polymer or polymer mixture is expelled through a die, with subsequent drawing of the molten extrudate, solidification of the extrudate by heat transfer to a surrounding fluid medium, and taking up of the solid extrudate on a godet or another take-up surface, e.g. a belt. The extrusion die may be a conventional die, for example, a spinnerette typically containing three or more orifices up to several hundred or several thousand orifices. The spinnerette typically includes a filter element to remove gels and other impurities which might otherwise foul or clog the spinnerette orifices. Typically, the spinnerette also includes a breaker plate to allow uniform distribution of the molten polymer mass which is supplied from an extruder and/or a gear pump, to all orifices of the spinnerette. Melt spinning may also include cold drawing, heat treating and/or texturizing. An important aspect of the fiber forming process is the orientation of the polymer molecules by drawing the polymer or polymer mixture in the molten state as it leaves the spinnerette. The fiber forming process may involve, for example, continuous filament forming, staple fiber forming, a spun bond or an air jet process or a melt blown process. It is desirable to spin the fiber at high speeds.

Preferred fibers of the invention comprise a blend of an ungrafted ethylene homopolymer or an ungrafted ethylene/C₃-C₂₀ alpha-olefin copolymer with a graft substantially random interpolymer . Such fibers include multiconstituent, preferably biconstituent fibers as well as ,multicomponent fibers, preferably bicomponent fibers. For example, the biconstituent fibers of the present invention may comprise a continuous phase of either the graft interpolymer or the ungrafted ethylene homopolymer or copolymer with the other component being dispersed therein in a matrix/fibril orientation. In multicomponent or bicomponent fibers with a sheath/core arrangement, one or more graft substantially random interpolymers are comprised in either the sheath or the core, or in both, advantageously blended with an ungrafted polymer, such as polypropylene homopolymer or copolymer, polystyrene, polyamide, substantially random interpolymers or polyester terephthalate (PET). Bicomponent fibers preferably comprise the grafted interpolymer and an ungrafted polymer component in the same continuous phase. The ratio of ungrafted polymer to grafted substantially random interpolymer generally depends on the graft level and the desired bonding level. A suitable ratio, for example is in the range of from about 95/5 to about 80/20 ungrafted polymer/graft substantially random interpolymer. The ungrafted and grafted blend components may be blended together prior to extrusion using methods and equipment generally known in the art, e.g. by melt blending or dryblending. The fibers of the invention are typically fine denier filaments of 15 denier or less down to fractional deniers, depending on the desired properties and the specific application in which they are to be used.

The fibers of the present invention have a wide variety of applications.

Yet another aspect of the present invention relates to the fibers of the invention in a blend of fibers, e.g. additionally comprising performance fibers. The fibers of the present invention are particularly useful in binder fiber applications with high tenacity performance fibers such as, for example, fibers from polyamides, polyesters, cotton, wool, silk, cellulosics, modified cellulosics such as rayon and rayon acetate, and the like. The fibers of the present invention find particular advantage as binder fibers owing to their adhesion to performance fibers and wettability thereof which is enhanced by the presence of the functional (polar) groups in the graft interpolymer and the relatively lower melting temperature or range of the grafted interpolymer constituent relative to the perfomance fiber.

In still another aspect, the present invention relates to a fabric, non-woven or woven, comprising the fibers of the invention, or fiber blends comprising the fibers of the invention. For example, the fibers may be formed into a batt and heat treated by calendaring on a heated, embossed roller to form a fabric. The batts may also be heat bonded, for example, by infrared light, ultrasound or the like, to obtain a light loft fabric. The fibers may also be employed in conventional textile processing such as carding, sizing, weaving and the like. Woven fabrics made from the fibers of the present invention may also be heat treated to alter the properties of the fabric.

The following examples are illustrative of the invention, but are not to be construed as to limiting the scope thereof in any manner.

### EXAMPLES

Test Methods

a) Melt Flow and Density Measurements

The molecular weight of the substantially random interpolymers used in the present invention is conveniently indicated using a melt index measurement according to ASTM D-1238, Condition 190° C./2.16 kg (formerly known as “Condition (E)” and also known as I₂) was determined. Melt index is inversely proportional to the molecular weight of the polymer. Thus, the higher the molecular weight, the lower the melt index, although the relationship is not linear.

Also useful for indicating the molecular weight of the substantially random interpolymers used in the present invention is the Gottfert melt index (G, cm³/10 min) which is obtained in a similar fashion as for melt index (I₂) using the ASTM D1238 procedure for automated plastometers, with the melt density set to 0.7632, the melt density of polyethylene at 190° C.

The relationship of melt density to styrene content for ethylene-styrene interpolymers was measured, as a function of total styrene content, at 190° C. for a range of 29.8% to 81.8% by weight styrene. Atactic polystyrene levels in these samples was typically 10% or less. The influence of the atactic polystyrene was assumed to be minimal because of the low levels. Also, the melt density of atactic polystyrene and the melt densities of the samples with high total styrene are very similar. The method used to determine the melt density employed a Gottfert melt index machine with a melt density parameter set to 0.7632, and the collection of melt strands as a function of time while the I₂ weight was in force. The weight and time for each melt strand was recorded and normalized to yield the mass in grams per 10 minutes. The instrument's calculated I₂ melt index value was also recorded. The equation used to calculate the actual melt density is

δ=δ0.7632×I₂/I₂ Gottfert

where δ0.7632=0.7632 and I_{2 Gottfert}=displayed melt index.

A linear least squares fit of calculated melt density versus total styrene content leads to an equation with a correlation coefficient of 0.91 for the following equation:

δ=0.00299×S+0.723

wherein S=weight percentage of styrene in the polymer. The relationship of total styrene to melt density can be used to determine an actual melt index value, using these equations if the styrene content is known.

So for a polymer that has a 73% total styrene content with a measured melt flow (the “Gottfert number”), the calculation becomes:

δ=0.00299*73+0.723=0.9412

where 0.9412/0.7632=I₂/G# (measured)=1.23.

b) Styrene Analyses

Interpolymer styrene content and the concentration of atactic polystyrene homopolymer impurity in the ESI (substantially random ethylene styrene interpolymer(s)) are determined using proton nuclear magnetic resonance (¹H NMR). All proton NMR samples are prepared in 1,1,2,2-tetrachloroethane-d2 (tce-d₂). The resulting solutions contain from about 1.6 to about 2.4 weight percent of interpolymer. The interpolymers are weighed directly into 5-mm sample tubes. A 0.75-ml aliquot of tce-d2 is added by syringe and the tube is capped with a tight-fitting cap. The samples are heated at 85° C. to soften the interpolymer. To provide mixing, the capped samples are occasionally brought to reflux using a heat gun.

Proton NMR spectra are accumulated with the sample probe at 80° C., and referenced to the residual protons of tce-d₂ at 5.99 ppm. Data is collected in triplicate on each sample. The following instrumental conditions are used for analysis of the interpolymer samples:

Sweep width, 5000 Hz

Acquisition time, 3.002 sec

Pulse width, 8 μsec

Frequency, 300 MHz

Delay, 1 see

Transients, 16

The total analysis time per sample is about 10 minutes.

Initially, a spectrum for a sample of a 192,000 M_{w} polystyrene is acquired. Polystyrene has five different types of protons that are distinguishable by proton NMR. In FIG. 1, these protons are labeled b, branch; α, alpha; o, ortho; m, meta; p, para, as shown in FIG. 1. For each repeating unit in the polymer, there are one branch proton, two-alpha protons, two ortho protons, two meta protons and one para proton.

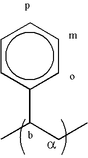

FIG. 1

The NMR spectrum for polystyrene homopolymer includes a resonance centered around a chemical shift of about 7.1 ppm, which is believed to correspond to the three ortho and para protons. It includes another peak centered around a chemical shift of about 6.6 ppm. That peak corresponds to the two meta protons. Other peaks at about 1.5 and 1.9 ppm correspond to the three aliphatic protons (alpha and branch).

The relative intensities of the resonances for each of these protons are determined by integration. The integral corresponding to the resonance at 7.1 ppm is designated PS_{7.1} below. That corresponding to the resonance at 6.6 ppm is designated PS_{6.6,} and that corresponding to the aliphatic protons (integrated from 0.8-2.5 ppm) is designated PSₐₗ. The theoretical ratio for PS_{7.1}: PS_{6.6}: PSₐₗ is 3:2:3, or 1.5:1:1.5. For atactic polystyrene homopolymer, all spectra collected have the expected 1.5:1:1.5 integration ratio. An aliphatic ratio of 2 to 1 is predicted based on the protons labeled α and b respectively in FIG. 1. This ratio is also observed when the two aliphatic peaks are integrated separately. Further, the ratio of aromatic to aliphatic protons is measured to be 5 to 3, as predicted from theoretical considerations.

Then, the ¹H-NMR spectrum for the ESI interpolymer is acquired. This spectrum shows resonances centered at about 7.1 ppm, 6.6 ppm and in the aliphatic region. However, the 6.6 ppm peak is relatively much weaker for the ESI interpolymer than for the polystyrene homopolymer. The relative weakness of this peak is believed to occur because the meta protons in the ESI copolymer resonate in the 7.1 ppm region. Thus, the only protons that produce the 6.6 ppm peak are meta protons associated with atactic polystyrene homopolymer that is an impurity in the ESI. The peak centered at about 7.1 ppm thus includes ortho, meta and para protons from the aromatic rings in the ESI interpolymer, as well as the ortho and para protons from the aromatic rings in the polystyrene homopolymer impurity. The peaks in the aliphatic region include resonances of aliphatic protons from both the ESI interpolymer and the polystyrene homopolymer impurity.

Again, the relative intensities of the peaks are determined by integration. The peak centered around 7.1 ppm is referred to below as I_{7.1}, that centered around 6.6 ppm is I_{6.6} and that in the aliphatic regions is Iₐₗ.

I_{7.1} includes a component attributable to the aromatic protons of the aromatic protons of the ESI interpolymer and a component attributable to the ortho and para protons of the aromatic rings of the polystyrene homopolymer impurity. Thus,

I_{7.1}=I_{c7.1}+I_{ps7.1}

where I_{c7.1} is the intensity of the 7.1 ppm resonance attributable to the aromatic protons in the interpolymer and I_{ps7.1} is the intensity of the 7.1 ppm resonance attributable to the ortho and meta protons of the polystyrene homopolymer.

From theoretical considerations, as confirmed by the ¹H NMR spectrum of the polystyrene homopolymer, the intensity of the 7.1 ppm resonance attributable to the polystyrene homopolymer impurity (I_{ps7.1}), equals 1.5 times the intensity of the 6.6 ppm resonance. This provides a basis for determining I_{c7.1} from measured values, as follows:

I_{c7.1}=I_{7.1}−1.5(I_{6.6}).

Similarly, Iₐₗ can be resolved into resonances attributable to the ESI and the polystyrene homopolymer impurity using the relationship

Iₐₗ=I_{cal}+Iₚₛₐₗ

wherein I_{cal is} the intensity attributable to the aliphatic protons on the interpolymer and Iₚₛₐₗ is the intensity attributable to the aliphatic protons of the polystyrene homopolymer impurity. Again, it is known from theoretical considerations and the spectrum from the atactic polystyrene homopolymer that Iₚₛₐₗ will equal 1.5 times I_{6.6}. Thus the following relationship provides a basis for determining I_{cal} from measured values:

I_{cal}=Iₐₗ−1.5(I_{6.6}).

The mole percent ethylene and styrene in the interpolymer are then calculated as follows:

s_{c}=I_{c7.1}/5

e_{c}=(I_{cal}−(3×s_{c}))/4

E=e_{c}/(s_{c}+e_{c}), and

S=s_{c}(s_{c}+e_{c}),

wherein E and S are the mole fractions of copolymerized ethylene and styrene, respectively, contained in the interpolymer.

Weight percent ethylene and styrene are calculated using the equations

$$Wt \% E = \frac{100 \% * 28 E}{( 28 E + 104 S )} and$$

$$2 Wt \% S = \frac{100 \% * 104 S}{( 28 E + 104 S )} .$$

The weight percent of polystyrene homopolymer impurity in the ESI sample is then determined by the following equation:

$$Wt \% PS = \frac{100 \% * Wt \% S * ( {I}_{6.6} / 2 S )}{100 - [ Wt \% S * ( {I}_{6.6} / 2 S ) ]} .$$

The total styrene content was also determined by quantitative Fourier Transform Infrared spectroscopy (FFIR).

c) Molecular Weight Analysis

Equipment: PL-Gel Permeation Chromatograph Model 210 (from Polymer Laboratories) with light scattering detector PD 2040 (from Precision Detectors)

PL-Caliber software version 7.0—(from Polymer Laboratories)

3 columns (PLgel 10 μm MIXED-B part number 1110-6100DW)—(from Polymer Laboratories)

Materials: Polystyrene calibration kit S-M-10/44 (from Polymer Laboratories), polystyrene standard 9.000.000 and 2.160.000 (from Wyatt)

1,2,4-trichlorobenzene for GPC, filtered (0.2 μm), stablized with BHI (500 ppm by weight)—(from Fisher Scientific)

Procedure: Add about 27 mg of the sample into a 20 ml vial. Add about 15 mg of BHT, then 15 ml stablized 1,2,4-trichlorobenzene. Dissolve the samples by shaking 90 min at 150° C. Aliquot 2 ml of solution into the SEC autosampler.

Conditions: The eluent (stablized 1,2,4-trichlorobenzene) is degased on line. The solvent flow rate is 1 ml/min.; 200 μl are injected. The analysis are carried out at 140° C. In order to avoid thermal stress for the samples in the autosampler during waiting for injection, the vials are kept ready at 80° C. until 1 h before analyzing. The calibration of the columns was done via a calibration kit from Polymer Laboratories. The molecular weights of the polystyrene standards were confirmed by light scattering measurements. The polystyrene calibration curve was transformed into a calibration curve for polyethylene using the following Kuhn-Mark-Houwink relations:

[η]=9,53×10⁻⁷×M^{0,725} for polystyrene

[η]=40,6×10⁻⁵×M^{0,725} for polyethylene

d) Determination of Graft Content: The content of grafted maleic acid on the interpolymer was measured by the following process: the graft interpolymer was washed with methanol, the washed polymer was dried and the total carbonyl content on the interpolymer was measured by FTIR analysis, according to the process of P. A. Callais and R. T. Kazmierczak, presented at the 1989 ANTEC Meeting on May 1-4, 1989.

### Example 1

Production of Ethylene-Styrene Interpolymer Grafts: The ethylene-styrene interpolymers were prepared as described in U.S. Pat. No. 5,703,187 and also in U.S. application Ser. No. 09/488,220, filed Jan. 19, 2000 and are available from the Dow Chemical Company.

The grafted samples were prepared by feeding a mixture of polymer, reactive monomer and initiator into a Werner-Pfleiderer ZSK 30 twin screw extruder. The reactive monomer was maleic anhydride, the initiator was 2,5-dimethyl-2,5-di(t-butylperoxy)hexane, the polymers were Ethylene Styrene Interpolymers with different styrene content (30 wt %, 70 wt %) and with different melt index (1 g/10 min and 10 g/10 min). The weight ratio of MAH/initiator/polymer was 1.5/0.05/98.45%.

The operating conditions of the twin screw extruder were:

| Barrel Temp. (1-5, Die) | 80° C., 150° C., 200° C., 200° C., 150° C., | |
|---|---|---|
| | 150° | C. |
| Melt Temp. (4) | 210° | C. |
| Melt Temp. (Die) | 150° | C. |
| Screw speed | 150 | rpm |
| Output | 8 | kg/h |

Using ventilation on die and feed hopper; using vacuum for devolization of free monomers is necessary.

The melt index and maleic anhydride content of the graft-modified and unmodified (starting) interpolymers are listed in the below table.

| | | MI | | Wt. % | | |
|---|---|---|---|---|---|---|
| | Wt. % | before | MI after | Grafted | | |
| ESI | Styrene | reactive | reactive | MAH | | |
| Sample | Content | extrusion | extrusion | Content¹⁾ | M_{w} | Mₙ |
| 1 | 30²⁾ | 1.1 | — | 0 | 79900 | 31700 |
| 2 | 30²⁾ | 1.1 | 1.0 | 0.3 | 75200 | 29700 |
| 3 | 30²⁾ | 10 | — | 0 | 51100 | 10300 |
| 4 | 30²⁾ | 10 | 9.8 | 0.2 | 48900 | 9800 |
| 5 | 70³⁾ | 1.6 | — | 0 | — | — |
| 6 | 70³⁾ | 1.6 | 1.3 | 0.3 | — | — |

¹⁾after methanol extraction, the total carbonyl content was measured by FTIR/Publication of Elf Atochem by P. A. Callais and R. T. Kazmierczak, presented at the 1989 ANTEC May 1-4, 1989
²⁾solvent for MAH was MEK (methyl ethyl ketone)
³⁾solvent for MAH was Isopropanol.

The data clearly indicate that no significant crosslinking or chain scission of the polymer occurs during the grafting reaction.

### Example 2

1) Preparation of Interpolymers

Substantially random ethylene/styrene interpolymer (ESI) no.7 and substantially random ethylene/propylene/styrene interpolyer (EPS) no. 1 were prepared in a continuously operating loop reactor. An Ingersoll-Dresser twin screw pump provided the mixing. The reactor ran liquid full at 475 psig (3,275 kPa). Raw materials and catalyst/cocatalyst flows were fed into the reactor through injectors and Kenics static mixers in the loop reactor piping. From the discharge of the loop pump, the process flow went through two shell and tube heat exchangers before returning to the suction of the loop pump. Upon exiting the last exchanger, loop flow returned through the injectors and static mixers to the suction of the pump. A second monomer/feed injector and mixer were used if available. Heat transfer oil or tempered water was circulated through the exchangers' jacket to control the loop temperature. The exit stream of the loop reactor was taken off between the two exchangers. The flow and solution density of the exit stream was measured by a Micro-Motion™ mass flow meter.

Solvent was injected to the reactor primarily as part of the feed flow to keep the ethylene in solution. A split stream from the pressurization pumps prior to ethylene injection was taken to provide a flush flow for the loop reactor pump seals. Additional solvent was added as a diluent for the catalyst. Feed solvent was mixed with uninhibited styrene monomer on the suction side of the pressurization pump. The pressurization pump supplies solvent and styrene to the reactor at approximately 650 psig (4,583 kPa). Fresh styrene flow was measured by a Micro-Motion™ mass flow meter, and total solvent/styrene flow was measured by a separate Micro-Motion™ mass flow meter. Ethylene was supplied to the reactor at approximately 690 psig (4,865 kPa). The ethylene stream was measured by a Micro-Motion™ mass flow meter. A flow meter/controller was used to deliver hydrogen into the ethylene stream at the outlet of the ethylene control valve. Propylene was added either as a high pressure stream after the solvent pressurization pump. The ethylene/hydrogen mixture was at ambient temperature when it was combined with the solvent/styrene stream. The temperature of the entire feed stream as it entered the reactor loop was lowered to approximately 2° C. by a glycol cooled exchanger.

The catalyst system was a three component system composed of a titanium catalyst, an aluminum co-catalyst and a boron co-catalyst. Preparation of the three catalyst components takes place in three separate tanks. The titanium catalyst was (1H-cyclopenta[1]phenanthrene-2-yl)dimethyl(t-butylamido)-silanetitanium 1,4diphenylbutadiene) which was prepared as described under II) below. The aluminum co-catalyst component was a modified methylaluminoxane type 3A (MMAO-3A; CAS No. 146905-79-5) and the boron co-catalyst was tris(pentafluorophenyl)borane (FAB, CAS No. 001109-15-5). The molar ratios of boron co-catalyst to titanium catalyst (B/Ti) and aluminum co-catalyst to titanium catalyst (Al/Ti) which were employed to prepare the various individual interpolymers were listed in Table 1.

TABLE 1
Catalyst Molar Ratios used in the preparation of ESI 1-4 and EPS-1

| Polymer | B/Ti molar ratio | Al/Ti molar ratio |
|---|---|---|
| ESI-7 | 5.5 | 8.3 |
| EPS-1 | 4 | 5 |

Fresh solvent and concentrated catalyst/co-catalyst/secondary co-catalyst premix were added and mixed into their respective run tanks and fed into the reactor via a variable speed Pulsafeeder™ diaphragm pumps. As previously explained, the three component catalyst system entered the reactor loop through an injector and static mixer into the suction side of the twin screw pump. The raw material feed stream was also fed into the reactor loop through an injector and static mixer upstream of the catalyst injection point or through a feed injector/mixer between the two exchangers.

Polymerization was stopped with the addition of catalyst kill (water) into the reactor product line after the Micro-Motion™ mass flow meter measuring the solution density. A static mixer in the line provided dispersion of the catalyst kill and additives in the reactor effluent stream. This stream next entered post reactor heaters that provided additional energy for the solvent removal flash. This flash occurred as the effluent exits the post reactor heater and the pressure was dropped from 475 psig (3,275 kPa) down to approximately 450 mmHg (60 kPa) of absolute pressure at the reactor pressure control valve.

This flashed polymer entered the devolatilization section of the process. The volatiles flashing from the devolatilization were condensed with a glycol jacketed exchanger, passed through vacuum pump, and were discharged to vapor/liquid separation vessel. In the first stage vacuum system, solvent/styrene were removed from the bottom of this vessel as recycle solvent while unreacted ethylene exhausted from the top. The ethylene stream was measured with a Micro-Motion™ mass flow meter. The measurement of vented ethylene plus a calculation of the dissolved gases in the solvent/styrene stream were used to calculate the ethylene conversion. The polymer and remaining solvent were pumped with a gear pump to a final devolatilizer. The pressure in the second devolatilizer was operated at approximately 10 mmHg (1.4 kPa) absolute pressure to flash the remaining solvent. The dry polymer (<1000 ppm total volatiles) was pumped with a gear pump to an underwater pelletizer, spin-dried, and collected.

The process conditions and amounts of monomers used to prepare the individual ethylene styrene interpolymers were summarized in Table 2.

TABLE 2
Process Conditions for Preparation of ESI-7 and EPS-1

| | Reactor | Solvent | Ethylene | Propylene | Hydrogen | Styrene | Ethylene |
|---|---|---|---|---|---|---|---|
| Inter- | Temp. | Flow | Flow | Flow | Flow | Flow | Conversion |
| polymer | ° C. | kg/h | kg/h | kg/h | kg/h | kg/h | % |
| ESI-7 | 115 | 10247 | 1427 | 0 | 0.174 | 659 | 93.7 |
| EPS-1 | 115 | 8543 | 1133 | 237 | 0 | 296 | 88.8 |

Table 3 lists certain properties characterizing the intelpolymers used in the Examples. Interpolymer styrene content, interpolymer propylene content and content of atactic polystyrene were determined using the proton nuclear magnetic resonance method described hereinbefore.

TABLE 3
Properties of ESI-7 and EPS-1

| | Interpolymer | Interpolymer | Atactic | |
|---|---|---|---|---|
| Inter- | Styrene | Propylene | Polystyrene | Melt Index |
| polymer | weight % | weight % | weight % | g/10 min |
| ESI-7 | 30.5 | 0 | 0.2 | 9.68 |
| EPS-1 | 14.1 | 16.5 | 0.1 | 1.23 |

II) Preparation of the Titanium Catalyst

1) Preparation of Lithium 1H-cyclopenta[1]phenanthrene-2-yl

To a 250 mL round-bottom flask containing 1.42 g (0.00657 mole) of 1H-cyclopenta[1]phenanthrene and 120 mL of benzene was added dropwise 4.2 mL of a 1.60 M solution of n-butyllithium in mixed hexanes. The solution was allowed to stir overnight. The lithium salt was isolated by filtration, washed twice with 25 mL benzene and dried under vacuum. ¹H-NMR analysis indicates the predominant isomer was substituted at the 2 position.

2) Preparation of (1H-cyclopenta[1]phenanthrene-2-yl)dimethylchlorosilane

To a 500 mL round bottom flask containing 4.16 g (0.0322 mole) of dimethyldichlorosilane (Me₂SiCl₂) and 250 mL of tetrahydrofuran (THF) was added dropwise a solution of 1.45 g (0.0064 mole) of lithium 1H-cyclopenta[1]-phenanthrene-2-yl in THF. The solution was stirred for approximately 16 hours, after which the solvent was removed under reduced pressure, leaving an oily solid which was extracted with toluene, filtered through a diatomaceous earth filter aid (Celite™), washed twice with toluene and dried under reduced pressure.

3) Preparation of (1H-cyclopenta[1]phenanthrene-2-yl)dimethyl(t-butylamino)silane

To a 500 mL round-bottom flask containing 1.98 g (0.0064 mole) of (1H-cyclo-penta[1]phenanthrene-2-yl)dimethylchlorosilane and 250 mL of hexane was added 2.00 mL (0.0160 mole) of t-butylamine. The reaction mixture was allowed to stir for several days, then filtered using a diatomaceous earth filter aid (Celite™) and washed twice with hexane. The product was isolated by removing residual solvent under reduced pressure.

4) Preparation of dilithio (1H-cyclopenta[1]phenanthrene-2-yl)dimethyl(t-butylamido)silane

To a 250 mL round-bottom flask containing 1.03 g (0.0030 mole) of (1H-cyclo-penta[1]phenanthrene-2-yl)dimethyl(t-butylamino)silane) and 120 mL of benzene was added dropwise 3.90 mL of a solution of 1.6 M n-butyllithium in mixed hexanes. The reaction mixture was stirred for approximately 16 hours. The product was isolated by filtration, washed twice with benzene and dried under reduced pressure.

5) Preparation of (1H-cyclopenta[1]phenanthrene-2-yl)dimethyl(t-butylamido)silanetitanium Dichloride

To a 250 mL round-bottom flask containing 1.17 g (0.0030 mole) of TiCl₃.3THP and about 120 mL of THF was added at a fast drip rate about 50 mL of a THF solution of 1.08 g of dilithio (1H-cyclopenta[1]phenanthrene-2-yl)dimethyl(t-butylamido)silane. The mixture was stirred at about 20° C. for 1.5 hours at which time 0.55 grams (0.002 mole) of solid PbCl₂ was added. After stirring for an additional 1.5 h the THF was removed under vacuum and the residue was extracted with toluene, filtered and dried under reduced pressure to give an orange solid.

6) Preparation of (1H-cyclopenta[1]phenanthrene-2-yl)dimethyl(t-butylamido)silanetitanium 1,4-diphenylbutadiene

To a slurry of (1H-cyclopenta[1]phenanthrene-2-yl)dimethyl(t-butylamido)-silanetitanium dichloride (3.48 g, 0.0075 mole) and 1.551 grams (0.0075 mole) of 1,4-diphenylbutadiene in about 80 mL of toluene at 70° C. was added 9.9 mL of a 1.6 M solution of n-BuLi (0.0150 mole). The solution immediately darkened. The temperature was increased to bring the mixture to reflux and the mixture was maintained at that temperature for 2 hours. The mixture was cooled to about −20° C. and the volatiles were removed under reduced pressure. The residue was slurried in 60 mL of mixed hexanes at about 20° C. for approximately 16 hours. The mixture was cooled to about −25° C. for about 1 hour. The solids were collected on a glass frit by vacuum filtration and dried under reduced pressure. The dried solid was placed in a glass fiber thimble and solid extracted continuously with hexanes using a soxhlet extractor. After 6 hours a crystalline solid was observed in the boiling pot. The mixture was cooled to about −20° C., isolated by filtration from the cold mixture, and dried under reduced pressure to give a dark crystalline solid. The filtrate was discarded. The solids in the extractor were stirred and the extraction continues with an additional quantity of mixed hexanes to give additional desired product as a dark crystalline solid.

III. Preparation of MAH Graft-Modified ESI-7 and EPS-1

The olefinically unsaturated organic monomer was maleic anhydride (MAH), the radical initiator was 2,5-Bis(tert-butylperoxy)-2,5-dimethylhexane (30% solution in a mineral oil). The weight ratios of MAH/initiator/interpolymer was 1.4/0.32/98.28 for ESI-7 and 1.4/0.5/98.1 for EPS-1. The grafting process for ESI-7 and EPS-1 is performed analogously to Example 1.

MAH-graft ESI-7 had a melt index of 7.8 and a MAH graft content of 0.6 weight %; MAH-graft EPS-1 had a MAH graft content of 0.95%. The graft content was measured via FTIR spectroscopy on compression molded films with a thickness of about 0.1 mm—free MAH was removed during the compression molded process.

IV. Fibers comprising MAH-Graft ESI-7 Show Superior Spinning Performance

Fibers comprising the MAH-graft ESI-7 were formed on a spinning line. A blend of 10% by weight of MAH graft ESI-7 and 90 weight percent of an ethylene/octene copolymer (0.95 g/ccm density; 17 Melt Index) was extruded on a standard screw extruder with an L/D of 28 and a compression ratio of 2.5 at 180° C. The molten extrudate was fed through a gear pump into a spin pack including a three layer filter system of 0.065/0.030/0.16 micron and a spinnerette having 400 0.31 mm holes with an L/D of 6.8. The molten filaments were drawn down to about 11 denier by the extensional force of a draw down godet at 120 m/min and winded up. The maximum spinning speed (fiber drawing) before fiber break was 120 m/min (which reflects the machine limit). In comparison, the maximum spinning speed for analogously formed fibers consisting of 100% of the ethylene/octene copolymer was only 90 m/min. The maximum spinning speed for analogously formed fibers consisting of 10% of MAHgraft HDPE (0.953 density, melt index of grafted HDPE 9.8; melt index before grafting 65; MAH graft content of 1.17) and 90% of the ethylene/octene copolymer was only 60 m/min.

V. Bicomponent Fibers Incorporating MAH-Graft ESI-7

Compositions comprising the MAHgraft ESI-7 were used to make bicomponent fibers. The bicomponent fibers had a core/sheath arrangement, with the core made from polypropylene and the sheath formed from the below-identified blends comprising MAH graft ESI-7.

Sample List (Composition):

1) 20 MFR (230° C., 2.16 kg) polypropylene homopolymer (PP)/90% of an ethylene/octene copolymer (0.930 density)+10% MAH-graft ESI-7

2) 20 MFR PP/85% of a substantially random ethylene/styrene interpolymer (30 MI, 10 wt. % styrene)+15% MAHgraft ESI-7

The fiber description and properties are summarized below.

Fiber Description and Properties (Target):

1) Circular cross-section (50/50; core/sheath ratio)

2) 1.5-1.75 denier per filament

3) Above a 2.5 gpd tenacity

4) ⅛ inch staple cut.

5) Goulston 5550 spin lube at FOY (Finish on Yam) of 0.2-0.3%

Fiber Physical Properties (Obtained):

| | | Tenacity | |
|---|---|---|---|
| ID | Denier | (gpd) | Comments |
| Composition | 1.68 | 3.76 | Final lube level was |
| #1 | | | 0.20%. |
| Composition | 1.69 | 3.42 | Final lube level on |
| #2 | | | finished fiber was |
| | | | 0.34%. |

Spinning and Drawing Conditions on Composition #1:

| Condition | Measured Value |
|---|---|
| Extruder A (Sheath): | |
| Metering Pump, rpm | 32.2 |
| Extruder Pressure, psi | 1100 |
| Zone 1 Temp, (deg C.) | 165 |
| Zone 2 Temp, (deg C.) | 175 |
| Zone 3 Temp, (deg C.) | 185 |
| Zone 4 Temp, (deg C.) | 195 |
| Extruder B (Core): | |
| Metering Pump, rpm | 32.2 |
| Extruder Pressure, psi | 1100 |
| Zone 1 Temp, (deg C.) | 195 |
| Zone 2 Temp, (deg C.) | 204 |
| Zone 3 Temp, (deg C.) | 210 |
| Zone 4 Temp, (deg C.) | 220 |
| Spin Head Temperature (deg C.) | 222 |
| A pump block (deg C.) | 220 |
| B pump block (deg C.) | 221 |
| Quench air temp (deg C.) | 11.2 |
| A pack pressure, psi-left side | 808 |
| A pack pressure, psi-right side | 1045 |
| B pack pressure, psi-left side | 1150 |
| B pack pressure, psi-right side | 1063 |
| Spin finish speed, rpm | 20 |
| Finish type/level | Goulston 5550 at |
| | 2.5% in water |
| Denier roll speed, m/min | 900 |
| Feed roll speed, m/min | 994 |
| Draw roll speed #1, m/min | 997 |
| Draw roll speed #2, m/min | 1000 |
| Winder speed, m/min | 1025 |
| Measured as-spun denier, dpf | 6 |
| Drawing Conditions: | |
| No. 1 draw rolls, m/min | 25.2 |
| Temp, roll #1 (deg C.) | 40 |
| Temp, roll #2 (deg C.) | 45 |
| Temp, roll #3 (deg C.) | 50 |
| Temp, roll #4 (deg C.) | 60 |
| Temp, roll #% (deg C.) | 60 |
| No. 2 draw rolls. M/min | 100.8 |
| No. 2 draw rolls. M/min | 93.3 |
| Final Drafted denier, dpf | 1.68 |

The above fibers were mixed in with cellulose pulp at a 12% by weight loading (of binder fiber) and using an air-laid process, 100 gsm cores/pads were fabricated. Following the fabrication of the air-laid cores/pads, the cores/pads were heated in a platen press for up to 60 seconds at both 275 F and 300 F to facilitate the binder fibers to bond to the cellulose pulp. Following this step, 5-6 tensile specimens were cut out from each core/pad (and each of the above three binder fiber compositions) and tested in an Instron machine at 0.5″/min testing speed. The dry tensile strength (or binding strength) of each composition from the above tests is reported below.

Table Summarizing Dry Tensile Strength of Binder Fibers having MAH-g-ESI-7 in the sheath. Data is reported at two binding temperatures for a 100 gsm pads at a 12% binder loading.

| | Tensile Strength | Tensile Strength |
|---|---|---|
| Composition | at 275 F., psi | at 300 F., psi |
| Composition #1 | 17.5 | 15.7 |
| Composition #2 | 15.5 | 11.7 |

Using a sheath made from a higher % grafted ESI and/or a PET core enhanced performance over and above what was measured and obtained above can be reached.

What is claimed is:

1. A grafted interpolymer composition comprising the graft reaction product of one or more substantially random interpolymers, said interpolymer comprising
(1) polymer units derived from;
(a) at least one vinyl or vinylidene aromatic monomer, or
(b) at least one hindered aliphatic or cycloaliphatic vinyl or vinylidene monomer, or
(c) a combination of at least one aromatic vinyl or vinylidene monomer and at least one hindered aliphatic or cycloaliphatic vinyl or vinylidene monomer, and
(2) polymer units derived from at least one of ethylene and/or a C₃₋₂₀ α-olefin; and
(3) optionally polymer units derived from one or more of ethylenically unsaturated polymerizable monomers other than those derived from (1) and (2); and
one or more olefinically unsaturated organic monomers.

2. The interpolymer composition of claim 1 wherein the one or more substantially random interpolymers have an I₂ of at least 0.01 g/10 min, comprising;
(1) from 1 to 65 mole percent of polymer units derived from;
(a) at least one vinyl or vinylidene aromatic monomer, or
(b) at least one hindered aliphatic or cycloaliphatic vinyl or vinylidene monomer, or
(c) a combination of at least one aromatic vinyl or vinylidene monomer and at least one hindered aliphatic or cycloaliphatic vinyl or vinylidene monomer, and
(2) from 35 to 99 mole percent of polymer units derived from at least one of ethylene and/or a C₃₋₂₀ α-olefin; and
(3) from 0 to 20 mole percent of polymer units derived from one or more of ethylenically unsaturated polymerizable monomers other than those derived from (1) and (2);
said backbone being grafted with one or more olefinically unsaturated organic acid monomer(s).

3. The interpolymer composition according to claims 1 or 2, wherein said substantially random interpolymer is an ethylene/styrene interpolymer or an ethylene/propylene/styrene interpolymer.

4. A graft interpolymer composition according to any of claims 1 to 3, wherein the one or more olefinically unsaturated organic monomers are selected from the group consisting of an organic dicarboxylic acid and an anhydride thereof.

5. A graft interpolymer composition according to any of claim 1 to 4, wherein the olefinically unsaturated organic monomer is selected from the group consiting of maleic anhydride, fumaric anhydride, acrylic acid, methacrylic acid, itaconic acid and crotonic acid.

6. A graft inter polymer composition according to anyone of claims 1 to 5 comprising a maleic anhydride grafted ethylene/styrene interpolymer or a maleic anhydride grafted ethylene/propylene/styrene interpolymer.

7. A graft interpolymer composition which is the reaction product of a reactive melt processing operation in the temperature range of from about 50° C. to about 300° C. comprising one or more substantially random interpolymers, comprising;
(1) polymer units derived from;
(a) at least one vinyl or vinylidene aromatic monomer, or
(b) at least one hindered aliphatic or cycloaliphatic vinyl or vinylidene monomer, or
(c) a combination of at least one aromatic vinyl or vinylidene monomer and at least one hindered aliphatic or cycloaliphatic vinyl or vinylidene monomer, and
(2) polymer units derived from at least one of ethylene and/or a C₃₋₂₀ α-olefin; and
(3) optionally polymer units derived from one or more of ethylenically unsaturated polymerizable monomers other than those derived from (1) and (2);
and one or more olefinically unsaturated organic monomers.

8. A polymer blend comprising a graft interpolymer composition according to anyone of claims 1 to 7.

9. A blend according to claim 8 comprising one or more polymers selected from the group consisting of a polyethylene homopolymer or copolymer, a polypropylene homopolymer or copolymer and a polyamide.

10. A graft interpolymer composition or blend according to anyone of claims 1 to 9 comprising at least one filler.

11. A shaped or fabricated article comprising the graft interpolymer composition or the blend according to anyone of claims 1 to 10.

12. A multilayer composite material comprising at least one layer comprising a the graft interpolymer composition or blend according to anyone of claims 1 to 10.

13. Use of the graft interpolymer composition or blend according to anyone of claims 1 to 10 in a multilayer composite material suitable for packaging films, as self adhesive coating or as hot melt adhesive.

14. Use of a graft interpolymer composition or blend according to anyone of claims 1 to 10 for the bonding of fibers, fillers, substituents or to improve compatibility between components of systems, especially in polymeric compositions.

15. A fiber comprising the graft interpolymer composition or blend according to any of claims 1 to 10.

16. The fiber according to claim 15, which is a multicomponent fiber.

17. Use of a fiber according to claims 15 or 16 which is a binder fiber.

18. A graft polymer with a backbone of a hydrogenated or partially hydrogenated random styrene-butadiene rubber, said backbone being grafted with one or more olefinically unsaturated organic acid monomer(s).
